(19) United States
(12) Patent Application Publication
(10) Pub. No.: US 2025/0023819 A1
(43) Pub. Date: Jan. 16, 2025

(54) DEVICE AND METHOD FOR LIGHTWEIGHT CONTAINER PACKET PROCESSING IN IOT ENVIRONMENT

(71) Applicant: KOREA UNIVERSITY RESEARCH AND BUSINESS FOUNDATION, Seoul (KR)

(72) Inventors: Wonmi CHOI, Seoul (KR); Yeonho YOO, Seoul (KR); Gyeongsik YANG, Seoul (KR); Chuck YOO, Seoul (KR)

(21) Appl. No.: 18/769,154

(22) Filed: Jul. 10, 2024

(30) Foreign Application Priority Data
Jul. 11, 2023 (KR) 10-2023-0089667
Jan. 16, 2024 (KR) 10-2024-0006612

(51) Int. Cl. H04L 45/745

(52) U.S. Cl. CPC H04L 45/745

(57) ABSTRACT

Disclosed is a device and method for lightweight container packet processing in an Internet of things (IoT) environment. A packet processing method is performed by a server that provides a container environment to an IoT device and includes receiving a packet from a container assigned to the IoT device; determining a packet processing path to process the packet; processing the packet according to the determined packet processing path; and transmitting the packet of which packet processing is completed to an external network.

### CROSS-REFERENCE TO RELATED APPLICATION(S)

This application claims the benefit under 35 USC § 119(a) of Korean Patent Application No. 10-2023-0089667 filed on Jul. 11, 2023 and Korean Patent Application No. 10-2024-0006612 filed on Jan. 16, 2024 in the Korean Intellectual Property Office, the entire disclosure of which is incorporated herein by reference for all purposes.

### BACKGROUND

### 1. Field

The present invention relates to a packet processing lightweight technique of containers on Internet of things (IoT) devices, and more particularly, to a method and device for lightweight of a packet processing process by recycling information required for packet transmission to solve unnecessary central processing unit (CPU) processing bottleneck occurring in a repetitious network communication process for packets in the same network connection.

### 2. Description of Related Art

### Internet of Things (IoT) Device

The IoT device refers to a device that connects a sensor, software, and communication technology to a device with limited computing resources to collect, store, process, and analyze data. The IoT device is mainly used in smart industries that generate a large amount of data, such as a smart factory, a smart home, and a smart farm, and collects data and performs real-time feedback control based on analysis of the data. This control mechanism requires a short standby time and high-performance communication.

### Container Virtualization

The container virtualization refers to a scheme of packaging and executing applications and their necessary libraries by providing an independent user space while sharing a single host operating system. Through container technology, an administrator may efficiently manage and distribute services and may improve the overall resource utilization by dividing a single physical resource into a plurality of virtualized resources. Due to such advantages, the IoT device adopts the container technology to efficiently manage data collected from a plurality of sensors.

### Packet Processing Process for Containerized Applications to Perform Network Communication

A process running on an operating system goes through several layers of packet processing process in a kernel space to communicate with other hosts. A process running directly on the operating system generates a socket in the kernel area through a system call, adds a packet header through a transport layer, a network layer (IP layer), and a datalink layer, and then transmits a packet to transmission media through a physical interface. Meanwhile, the containerized process is connected to a host through a virtualization interface and thus, transmits the packet through an additional host layer. The packet that passes through the datalink layer is converted to a host address or added through the IP layer and the datalink layer in the kernel space of the host and then transmitted to the transmission media.

Terms used in the present specification are defined as follows.

Packet: The packet is a unit of a data block transmitted for communication between computers. In addition to data transmitted from a process, a number for identifying the data and source/destination addresses are recorded and an error check bit is also included.

Network connection: Communication between two processes running on two physical servers is called a single network connection. In general, the network connection is established using a connection-oriented transmission control protocol (TCP) and data is exchanged between processes through the network connection. In a user datagram protocol (UDP), unicast communication also exchanges data between two processes, so a single network connection may be established. In the present invention, if 5-tuple in TCP packet header information, that is, source IP address, destination IP address, source port address, destination port address, and transport layer protocol identifier (L4 protocol identifier) are identical, it is considered as a single TCP network connection.

Operating system: The operating system refers to software that serves as an interface between a process and hardware in a computer system and delivers an instruction of the process to hardware and provides necessary resources. To simultaneously run and operate smoothly a plurality of processes, the operating system allocates CPU resources through scheduling and manages memory and file system access control through lock or semaphore.

### SUMMARY

A technical subject to be achieved by the present invention is to solve central processing unit (CPU) bottleneck by reducing high CPU operation due to long packet processing that occurs in a process in which a program using container technology in an Internet of things (IoT) device performs network communication.

The container technology refers to technique that supports applications to run in an independent environment. Therefore, to transmit a packet sent from inside a container to the outside, the packet goes through an additional network stack in a host kernel in addition to the existing kernel network stack. As a result, higher CPU operation than a process running on a host is required in a kernel space, which causes greater overhead in the IoT device with limited computing resources. This is because CPU resources available to applications are reduced and this causes network performance to be degraded.

The existing studies largely employed two methods to improve the network performance of containers. A first method is to bypass a portion of the kernel network stack by converting a packet processing process to hardware or user space. This method has limitations in requiring special hardware that supports packet processing acceleration or having to modify operations of the existing applications. This is not suitable for IoT devices that operate in various hardware environments, such as Android and Raspberry Pi and use various protocols, such as message queuing telemetry transport (MQTT) and constrained application protocol (CoAP). A second method is to increase the number of packets processed per second by simultaneously using CPU resources of a plurality of cores. This method is suitable for a cloud environment with abundant computing resources, but not suitable for IoT devices that have limited computing resources and are difficult to expand.

A packet processing method according to an example embodiment is a packet processing method performed by a server that provides a container environment to an IoT device, including receiving a packet from a container assigned to the IoT device; determining a packet processing path to process the packet, processing the packet according to the determined packet processing path; and transmitting the packet of which packet processing is completed to an external network.

According to some example embodiments, it is possible to reduce packet processing latency and to improve network performance by solving CPU bottleneck occurring in a container network communication process on an IoT device. In a packet processing process, it is possible to solve overhead of the additional networking stack occurring in a host space by storing, in a memory, and reusing operations required for packet header processing. This technique is performed only at a kernel level and thus, separate hardware support or modification of applications is not required.

Therefore, the present invention is an effective technique to reduce CPU resource usage of a packet processing process and to improve network performance when using container technology on an IoT device in which repetitious network traffic occurs.

### BRIEF DESCRIPTION OF THE DRAWINGS

These and/or other aspects, features, and advantages of the disclosure will become apparent and more readily appreciated from the following description of example embodiments, taken in conjunction with the accompanying drawings of which:

FIG. 1, (a) and (b), illustrate detailed packet processing sequences of native Linux and a container, respectively;

FIG. 2, (a), (b), (c), and (d), illustrate central processing unit (CPU) usage, network throughput, and latency of containers on Internet of things (IoT) devices;

FIG. 3, (a) and (b), illustrate inadequacy of existing acceleration techniques on IoT devices;

FIG. 4, (a) and (b), illustrate root cause analysis results of difficulty on IoT container challenges;

FIG. 5 illustrates a design of a proposed method (SCON);

FIG. 6 illustrates a packet processing path of the proposed method (SCON);

FIG. 7 illustrates a table structure of the proposed method;

FIG. 8, (a) and (b), illustrate an HTTP traffic scenario;

FIG. 9, (a) and (b), illustrate an MQTT traffic scenario;

FIG. 10, (a) and (b), illustrate CPU usage for SoftIRQ;

FIG. 11, (a) and (b), illustrate network throughput;

FIG. 12, (a) and (b), illustrate latency per packet;

FIG. 13 illustrates a processing time per packet and function symbol;

FIG. 14 illustrates 99% tail FCT of IoT traffic;

FIG. 15, (a) and (b), illustrate CPU usage for SoftIRQ (UDP);

FIG. 16, (a) and (b), illustrate network throughput (UDP); and

FIG. 17 is a flowchart illustrating a packet processing method according to an example embodiment.

### DETAILED DESCRIPTION

The aforementioned features and effects of the disclosure will be apparent from the following detailed description related to the accompanying drawings and accordingly those skilled in the art to which the disclosure pertains may easily implement the technical spirit of the disclosure.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component.

For example, a first component may be referred to as a second component, or similarly, the second component may be referred to as the first component within the scope of the present disclosure. As used herein, the term “and/or” includes any and all combinations of one or more of the associated listed items.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Hereinafter, example embodiments will be described with reference to the accompanying drawings. However, the scope of the patent application is not limited to or restricted by such example embodiments. Like reference numerals used herein refer to like elements throughout.

Initially, container networking in Internet of things (IoT) devices and its packet processing sequence are described.

### 1. Container Networking in IoT Devices

A container has its unique Internet protocol (IP) address to ensure isolation from other containers. A network switch or a router connecting a host recognizes only an IP address of a host machine. Therefore, to deliver a packet generated from the container across the host, a container platform utilizes one of two techniques, network address translation (NAT) or overlay.

NAT. Each host manages a NAT table that maps a container address to a host address. Based on mapping results, the NAT modifies a packet header by replacing a container IP with a host IP. Therefore, a packet that traverses an external network carries the host address and the switch and/or the router may recognize and correctly deliver the packet between hosts.

Overlay. Overlay refers to a technique that utilizes an additional header. A container packet from a source host is encapsulated with an additional header (e.g., virtual extensible local area network (VXLAN) or international personality item pool (IPIP)) and then decapsulated at a destination host. An external network delivers a packet based on a host address in the additional header. Although the overlay successfully delivers the container packet between hosts, it is known that the overlay incurs bigger overhead in a central processing unit (CPU) and latency than NAT. This is because the overlay requires overhead for packet encapsulation/decapsulation processes. Also, if a packet size increases, the packet may be fragmented when the encapsulated packet size exceeds a maximum transmission unit, which is not a simple operation for an IoT device. Therefore, the NAT may be preferred for the IoT device with a limited amount of computing resources.

Various container platforms, such as Docker, LXC, and OpenVZ, utilize a bridge network. There are some other techniques that employ alternatives to the bridge, such as Open vSwitches, but their role is identical to that of the bridge. Since a NAT operation with the bridge network is a de facto standard in container networking with the IoT device, the focus herein is on the NAT with the bridge.

### 2. Packet Processing Sequence

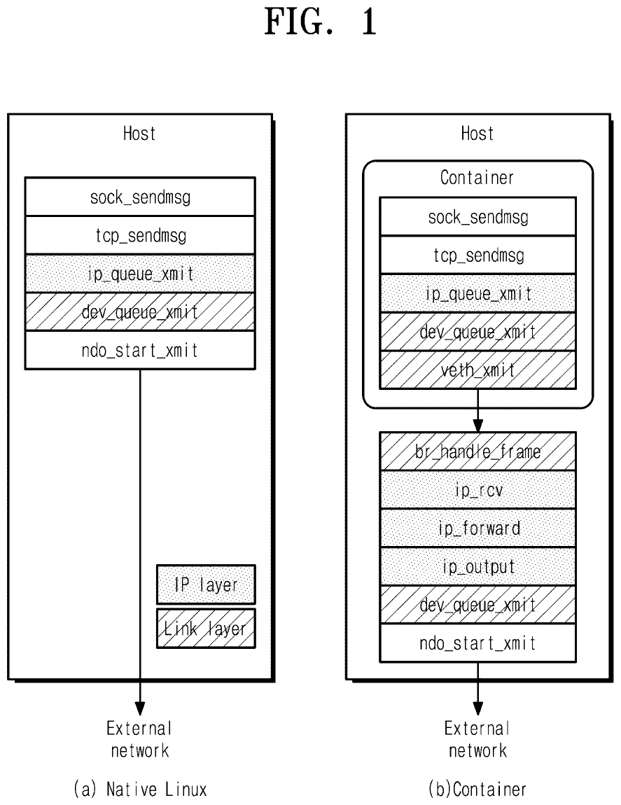

FIG. 1, (a) and (b), illustrate detailed packet processing sequences of native Linux and a container, respectively. Transmission control protocol (TCP) packet processing is explained as an example. Processing sequences for a TCP packet and a UDP packet are largely similar except for transport layer functions. For a transport layer, a TCP is relatively more complex than a UDP.

Initially, a function of the native Linux is described in (a) of FIG. 1. A packet from a user application passes through sock_sendmsg, a first function of a transport layer of a Linux networking stack. Then, tcp_sendmsg allocates memory spaces for data structures of metadata and payload of the packet (e.g., sk_buff) and establishes a connection to a remote destination host. After the connection is established, tcp_sendmsg calls an IP layer (ip_queue_xmit). An IP layer function conducts routing lookup and Netfilter processing. When a MAC address of a next hop is identified, the packet is transferred to a link layer (dev_queue_xmit) and further to a network interface layer (ndo_start_xmit). Finally, the packet is transmitted to an external network.

Next, a packet processing process in a container is described in (b) of FIG. 1. Functions in TCP and IP layers are the same as the native Linux. However, in a link layer of the container, dev_queue_xmit calls veth_xmit that transmits a packet to veth instead of an actual network device of a host. Here, veth is a virtual network interface assigned to each container by default and provides an isolated network address space. Each veth has unique MAC and IP addresses, so the container can be distinguished.

The packet passing through veth is delivered to the bridge. The bridge identifiers a MAC address of a veth interface of the container to forward the packet to a host-side network interface that performs NAT on the forwarded packet. Detailed operations of the bridge are as follows. Initially, address resolution protocol (ARP) table lookup is performed to identify the MAC address of the packet in br_handle_frame. Then, br_handle_frame performs Netfilter operations to determine a network interface used to transmit the packet. Finally, br_handle_frame transmits the packet to a corresponding network interface that leads to another IP layer processing. It is called a second IP layer.

In the second IP layer, ip_rcv, ip_forward, and ip_output are called in order. This call chain involves routing lookup that determines a proper destination IP of the packet and Netfilter operation that determines whether to forward the packet. In particular, NAT is conducted by Netfilter hook in ip_output in the IP layer that changes a source IP address of the packet from the IP address of the container to that of the host. After NAT from the second IP layer, the packet is delivered to an actual network interface of a host server (dev_queue_xmit), and the packet is finally transmitted (ndo_start_xmit).

Through analysis of the packet processing sequence, it can be known that the networking processing sequence of the container shown in (b) of FIG. 1 is much longer than that of the native Linux shown in (a) of FIG. 1.

Hereinafter, challenges of IoT containers and root cause analysis are explained.

Initially, the challenges of IoT containers include 1) inefficient CPU usage in IoT devices, 2) poor throughput and latency in IoT devices, and 3) inadequacy of existing acceleration techniques. Then, provided is an in-depth root cause analysis of challenges and outline of approach for a new kernel-level accelerator.

### 1. Challenges

Experiment settings. Challenges of IoT containers are shown through various experiments. For experiments, Raspberry Pi 4, which is a widely-used IoT device, is used. However, the scope of the present invention is not limited to types of the IoT device and various IoT devices may be used depending on example embodiments. Raspberry Pi 4 is equipped with an ARM Cortex-A72 64-bit quad core @ 1.5 GHz CPU, 8 GB of RAM, and a 1000 Mbps Ethernet chip. Linux version 5.10 is executed and containers are generated by Docker runtime version 20.10.

The Raspberry Pi is connected to an edge cloud server (server machine) by 1000 Mbps Ethernet. The server machine is equipped with an Intel i7-3770K octa-core@3.5 GHz CPU with 64 GB memory and 256 GB SSD. This server runs Linux version 5.4. TCP traffic is generated from a container on the Raspberry Pi to the server machine, using iperf. Here, iperf is one of most popular network benchmarks on IoT system evaluation. Unless otherwise specified, the experiment settings described here are used throughout the present specification.

For comparison, experiment with “native” was conducted on the same IoT device with the same settings (e.g., iperf). Experiment results are presented using a single CPU core for the container, which is a typical specification of resource-constrained IoT environments. Also, experiments were conducted with a higher number of cores (up to four cores), which shows similar trends to the following results.

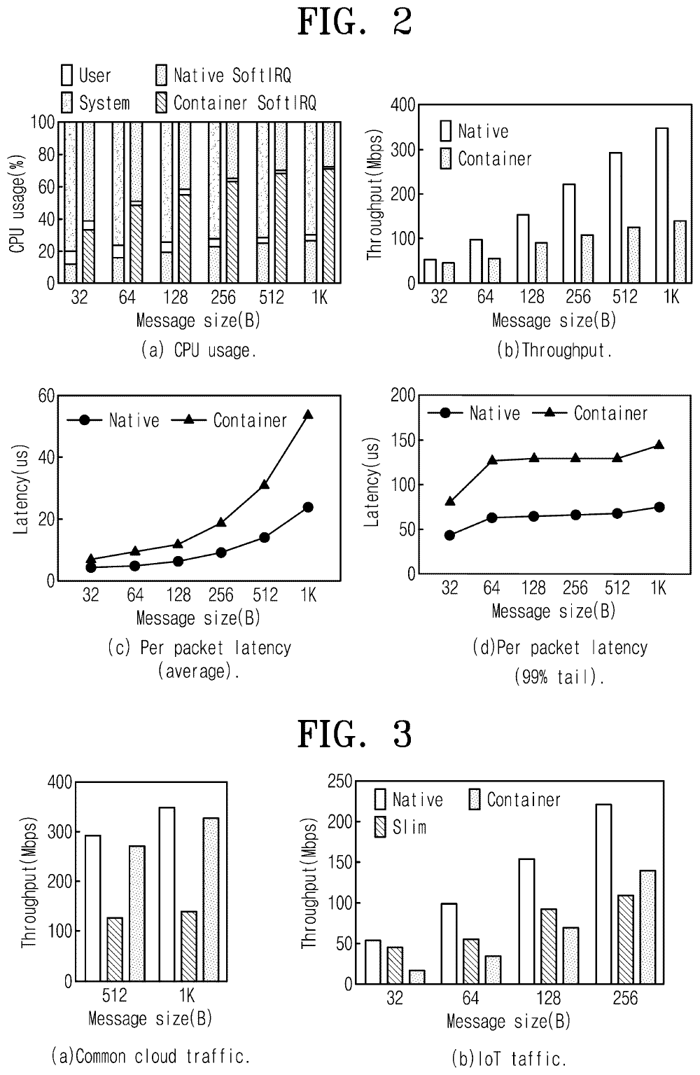

Challenge 1: Inefficient CPU usage in IoT devices. Initially, CPU usage in IoT devices is evaluated ((a) of FIG. 2). A size of a TCP packet is increased from 32 B to 1 KB (x-axis). Measurement results between the container and the native process are compared.

In (a) of FIG. 2, the native and the container in IoT fully utilize CPU, but detailed usage is different between the two. In particular, the CPU usage of the container for SoftIRQ processing is significantly higher compared to that of the native. For example, when processing 1 KB messages, container networking incurs up to 2.6× higher CPU usage than the native for SoftIRQ processing. The results negatively impact network throughput because fewer CPU resources become available for processing at a system level that handles system calls and at a user level that generates packets. This inefficient CPU usage poses a significant challenge for many IoT devices. In particular, many IoT devices are battery-powered and thus, highly sensitive to the CPU usage.

Challenge 2: Poor throughput and latency in IoT devices. Next, network throughput and latency for IoT devices are evaluated. (b) of FIG. 2 shows an increase in network throughput according to a message size. In particular, for 1 KB messages, the network throughput of the container is reduced by 59% compared to the native. On average, the container has 44% lower throughput than the native.

Per-packet transmission latencies of containers are evaluated in terms of average and 99% tail values measured by Netperf. The results show that both the average and the 99% tail latency increase. In particular, in (c) and (d) of FIG. 2, the container increases the average latency by double and the 99% tail latency also by double on average. Considering that IoT devices are frequently used for real-time communication (e.g., smart home automation, remote health monitoring, and factory control), improving network throughput and reducing latency is very important.

Challenge 3: Inadequacy of existing acceleration techniques. Since containers draw significant attention from the datacenter perspective, various networking acceleration studies have been conducted. However, the studies are inappropriate for IoT devices due to the following reasons.

First, existing studies lack interoperability for heterogeneous IoT devices. To accelerate networking, several studies changed kernel semantics in packet processing (e.g., kernel bypassing and user-level processing), and socket APIs of all legacy applications need to be modified. This implies that considerable development efforts are required to adapt the techniques to various heterogeneous IoT applications.

Other studies have proposed the use of additional hardware (e.g., remote direct memory access (RDMA) network interface card (NIC) or data plane development kit (DPDK) NIC). However, it is unclear whether NICs are readily available in IoT devices. Therefore, although these techniques may improve networking performance, the techniques may not provide interoperability for heterogeneous IoT devices that lack the necessary hardware support.

Second, such studies do not sufficiently accelerate IoT traffic. Experiments are conducted on the performance of open-source acceleration technique, Slim, latest and representative method that bypasses a portion of networking stack and does not require specialized hardware. On IoT devices, the performance of Slim is evaluated using iperf, which is the only benchmark found to be compatible with Slim on IoT devices. Slim includes a custom library for running legacy Linux applications. However, due to change in packet processing semantics (host bypassing), this library does not fully support native system calls (e.g., accept). There was an attempt to run IoT traffic applications, such as MQTT library, on Slim, but modifications were required. Therefore, the iperf results are presented here.

Throughput between the native, Slim, and the container is compared. A traffic size is classified into two categories, that is, 1) common cloud traffic (512 B and 1 KB) and 2) IoT traffic (32 B to 256 B). For the cloud traffic ((a) of FIG. 3), Slim improves network throughput by 66% than the container on average. When compared with the native, Slim shows only 14% lower throughput on average. However, for the IoT traffic ((b) of FIG. 3), Slim shows poor throughput compared to the native, with a decrease of 59% on average. Even compared to the container, Slim performs lower performance by 34% on average. The results represent that existing techniques are designed for large and long-lived cloud traffic, so fall short in enhancing throughput for the IoT traffic. This highlights the need for a new accelerator for the IoT traffic in container networking.

### 2. Root Cause Analysis and Our Approach

To design a new accelerator for IoT devices and traffic, the underlying causes of inefficient and poor CPU usage, network throughput, and latency are investigated. The IoT container networking stack is analyzed using ftrace. Specifically, an amount of time used to process each function symbol in the networking stack of IoT containers when transmitting 64 B TCP packets is measured.

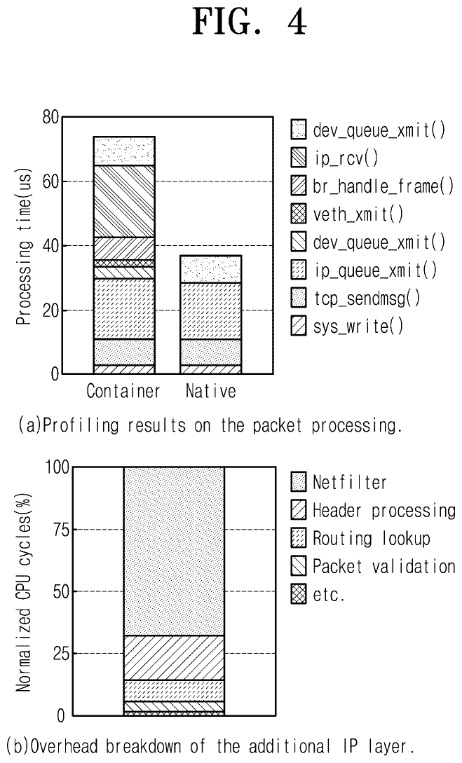

(a) of FIG. 4 illustrates the measurement results for key functions involved in packet processing in container networking, as discussed above. The results represent that an amount of time required for processing a single TCP packet in a container is twice as high as the native. This is because the container networking stack requires “additional” processing, such as bridge layer (br_handle_frame), a second IP layer (ip_rcv), and veth/eth (dev_queue_xmit and veth_xmit). Other parts in the container networking stack, such as TCP and IP layers, consume similar amounts of CPU time to a native environment.

The results show that the IP layer in additional processing accounts for a largest portion (63%). Therefore, additional analysis is conducted on packet processing in the IP layer. CPU cycles used for every symbol are measured and categorized into operations, for example, Netfilter, header processing, routing lookup, and packet validation. Each category implies the following operations:
Netfilter: indicates packet filtering provided by a Linux kernel. Netfilter also includes NAT processing that changes a packet source IP address of a container to a host server to enable external networking. A default configuration is used in experiments herein.
Header processing: recomputes a time-to-live (TTL) field and checksum values and allocates a packet header to expand a size of a header for NAT.
Routing lookup: determines a corresponding network interface of a packet to be transmitted.
Packet validation: checks whether the packet is local or remote in the Linux bridge.

Referring to (b) of FIG. 4, it can be known that the sum of Netfilter, header processing, and routing lookup occupies 94% of CPU cycles in additional packet processing. Deep analysis results show that the aforementioned three operations consume such a large amount of CPU cycles due to the following reasons. First, Netfilter performs NAT table lookup for external networking between containers. Also, Netfilter implements policies for firewalls or security, which includes IP table lookup according to the policies. Also, Netfilter requires expensive spin-lock operations, resulting in high CPU overhead. Furthermore, additional IP header processing is conducted for second IP layer processing. Also, routing requires a lookup over data structures (trie) for every received packet to find a proper destination.

Netfilter, header processing, and routing lookup are repeatedly conducted for every packet although a container transmits packets with the same source and destination pair. Therefore, when IoT devices transmits the traffic in a bursty manner, the CPU is significantly consumed, which leads to degrading throughput and latency.

So, herein, designed is a kernel accelerator on three high-overhead operations, such as 1) Netfilter, 2) header processing, and 3) routing lookup. The goals of a proposed method (which may also be referred to as SCON) are as follows:
Reduce repetitious resource consumption while improving networking throughput and latency for IoT network traffic.
Design a networking acceleration technique without hardware offloading support for IoT devices.
Avoid kernel semantic change or API change that results in application re-implementation.

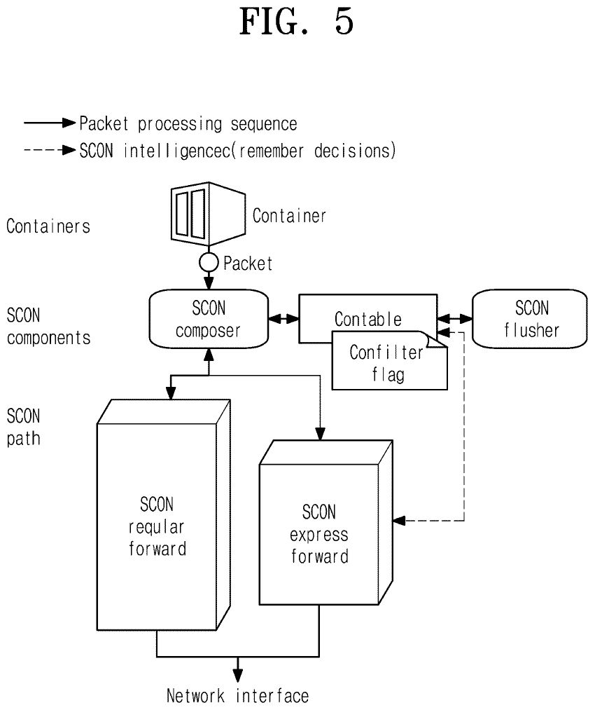

Hereinafter, presented is a detailed design of the proposed method (SCON) that offers high network performance with efficient CPU usage on IoT devices. FIG. 5 illustrates a design of the proposed method (SCON). To eliminate high-overhead operations observed above, proposed is a packet processing path (SCON path of FIG. 5) that includes a first packet processing process (SCON regular forward of FIG. 5, which may also be referred to as a first packet processing routine) and a second packet processing process (SCON express forward of FIG. 5, which may also be referred to as a second packet processing routine). To avoid repetitious operations in Netfilter, header processing, and routing lookup, “intelligence” is added to container packet processing. The intelligence of the proposed method (SCON) is to remember packet processing results (e.g., routing table lookup results) in the first packet processing process (SCON regular forward) for a recent connection.

In detail, when a packet from a container is delivered to the Linux bridge, the proposed method (SCON) distinguishes (or determines) which process between the first packet processing process (SCON regular forward) and the second packet processing process (SCON express forward) is a suitable routine to process the packet. If the packet belongs to a newly generated connection between source and destination containers (identifiable by 5-tuple information including source IP address, destination IP address, source port address, destination port address, and L4 protocol identifier), the packet moves to the first packet processing path (SCON regular forward). If the packet belongs to a network connection that the proposed method (SCON) has already seen recently, the packet goes to the second packet processing path (SCON express forward).

However, identifying 5-tuple information of every incoming packet without hardware offloading and API modification may cause significant overhead in the Linux bridge since the Linux bridge simultaneously handles packets from a plurality of containers. To reduce packet identification cost, proposed are the following components of the proposed method (SCON). that is, 1) table (referable to as Contable or packet processing result storage table) and flag (referable to as Confilter flag) as per-container structures for packing processing and 2) a table generator (SCON composer of FIG. 5) and a table manager (SCON flusher of FIG. 5) for allocating and managing the table (Contable). In the following, the packet processing path (SCON path) and the components of the proposed method (SCON) are explained one by one.

### 1. Packet Processing Path (SCON Path)

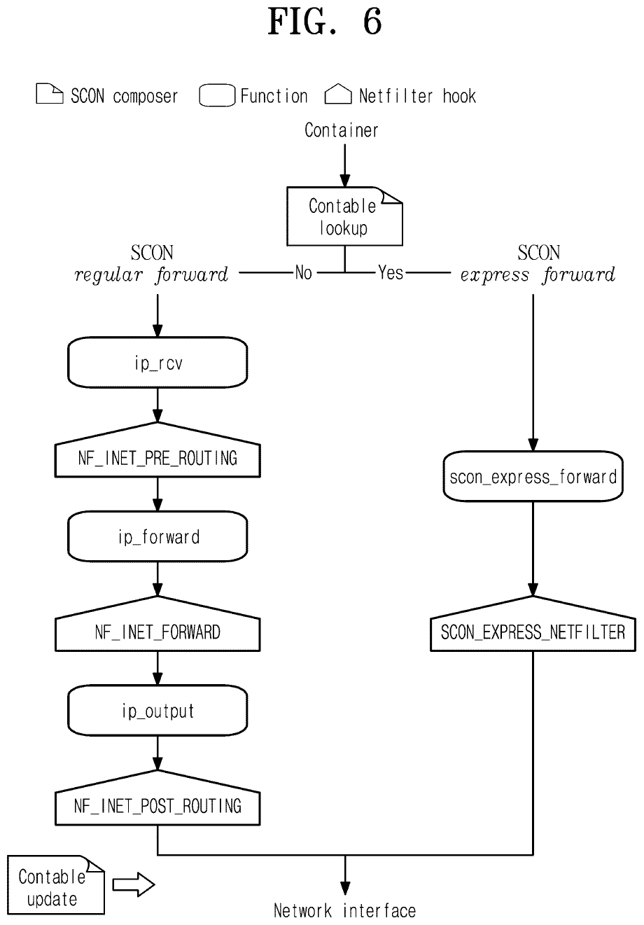

Initially, the first packet processing path (SCON regular forward) of the packet processing path (SCON path) is explained. Here, a packet follows call chain of the original Linux networking stack (see FIG. 6). While traversing the call chain, the proposed method (SCON) detects the packet and collects the packet processing results from Netfilter, routing lookup, and header processing, as listed below:
Netfilter: the results of NF_INET_PRE_ROUTING, NF_INET_FORWARD, and NF_INET_POST_ROUTING.
Routing lookup: IP and MAC addresses of a next hop.
Header processing: MTU size, TTL value, and IP layer (L3) protocol ID.

After the packet passes through the call chain, the proposed method (SCON) “memorizes” the collected packet processing results in a store called Contable and also stores an identifier of a network connection (5-tuple values) to which the packet belongs.

Next, the second packet processing path (SCON express forward) may avoid repetitious packet processing by utilizing the table (Contable) configured in the previous first packet processing path (SCON regular forward). The second packet processing path (SCON express forward) includes two parts, that is, 1) scon_express_forward and 2) SCON_EXPRESS_NETFILTER. Compared to the original, scon_express_forward offers lightweight alternatives for packet header processing and routing lookup, and SCON_EXPRESS_NETFILTER for Netfilter processing.

scon_express_forward retrieves the results stored in the table (Contable) and fills the packet with necessary header information (e.g., routing lookup result, TTL value, and MTU size). It also performs an essential checksum operation and transmits the same to SCON_EXPRESS_NETFILTER.

In SCON_EXPRESS_NETFILTER, the proposed method (SCON) reduces overhead of Netfilter processing (e.g., repetitious spin-locks for structure lookup) by memorizing the Netfilter decision stored in the table (Contable). The decision from Netfilter includes two actions, that is, 1) success and 2) discard. Success indicates that the packet is ready to go out immediately (including source NAT processing), so SCON_EXPRESS_NETFILTER transmits the packet to a network interface. Discard indicates that the packet needs to be dropped due to a security breach or firewall policy set by a system administrator.

To ensure the packet processing path (SCON path) operates as intended, a table (Contable) structure needs to be allocated and generated at proper time to store connection information intelligently. Also, it is necessary to update connection information stored in memory when a corresponding connection is terminated or when its characteristic changes (e.g., connection reset). The components of the proposed method (SCON) fulfill such a role, which is explained in detail in the following.

### 2. Components of the Proposed Method (SCON Components)

Hereinafter, four components of the proposed method (SCON), that is, 1) table (Contable), 2) flag (Confilter flag), 3) table generator (SCON composer), and 4) table manager (SCON flusher) are described.

2.1 Table (Contable). The table (Contable) structure is illustrated in FIG. 7. The table (Contable) memorizes how the packet of the connection is processed by the first packet processing path (SCON regular forward). Also, it identifies which packet processing path (SCON routine) each packet needs to take. The proposed method (SCON) maintains a separate table (Contable) per container, which includes a plurality of sub-table (Conentry of FIG. 7) structures linked as a linked list.

A sub-table (Conentry) is built and used for each connection. The proposed method (SCON) identifies both the sub-table (Conentry) and the connection through 5-tuple. Each sub-table (Conentry) maintains 1) routing information (i.e., IP routing, MAC routing, L3 protocol ID) and/or 2) flag (Confilter flag). IP routing stores a destination network interface (i.e., struct net_device) of the packet, the TTL value, and the MTU size of the corresponding interface collected from the first packet processing path (SCON regular forward). MAC routing stores link layer information of a next-hop server that receives the packet transmitted from the host server. The L3 protocol ID is an IP protocol number required for an IP header. The flag (Confilter flag) aggregates Netfilter operations and is a part of packet header processing, which is further described below.

2.2 Flag (Confilter flag). The flag (Confilter flag) of the table (Contable) includes 1) processing results from Netfilter and/or 2) header processing. That is, the table (Contable) may include information on Netfilter processing results and/or header processing results. Netfilter plays a role for a user or a system administrator to define rules for malicious or filterable network connections. Also, for normal network connection, Netfilter performs source NAT for external communication. The result from Netfilter is either 1) success or 2) discard, as described above.

During header processing, the packet header checksum is computed to detect an error in packet bits. This error is present per packet and does not persist over the entire connection to which the corresponding packet belongs. The result of header processing may be classified into 1) pass (normal) or 2) error (dropped).

When the packet (connection) is “success” from Netfilter and is “pass” from header processing, the proposed method (SCON) sets the flag (Confilter flag) as “success.” In this case, the first packet processing path (SCON regular forward) directly transmits the packet to the network interface. If the packet is discarded from Netfilter (regardless of the results of header processing), the proposed method (SCON) sets the flag (Confilter flag) as “discard” and the first packet processing path (SCON regular forward) drops the packet. Lastly, when the packet is considered “error” from header processing, a packet coming at a next time may pass through the first packet processing path (SCON regular forward) such that information of the table (Contable) may be updated. The flag (Confilter flag) of success, discard, and go-to first packet processing path (SCON regular forward) may be defined by integers (i.e., 1, −1, and 0).

2.3 Table generator (SCON composer). The table generator (SCON composer) serves to construct the table structure (Contable structure). When a packet is transmitted from a container, the table generator (SCON composer) looks up the table (Contable) to check if there is a sub-table (Conentry) that matches 5-tuple of the packet. If there is no matching sub-table (Conentry), it indicates that the packet belongs to new network connection not seen before. Therefore, the table generator (SCON composer) allocates a new sub-table (Conentry), adds the same to the table (Contable), connects the same to a previous sub-table (Conentry), and initializes corresponding entry. After the packet goes through a regular path of the proposed method (SCON), the table generator (SCON composer) updates the sub-table (Conentry) with the memorized processing information of the packet.

2.4 Table manager (SCON flusher). The table manager (SCON flusher) serves to remove a table (Contable) or sub-table (Conentry) structure that is no longer valid. There are some situations in which this structure becomes invalid. A first situation is when the corresponding container is stopped or removed in which case the table (Contable) allocated for the container is no longer used. For this case, each table (Contable) may be designed to be dependent on the container's interface (i.e., bridge port). This is because the container's interface is removed by a kernel when the container is stopped or removed. Therefore, when the container is stopped or removed, the table (Contable) is removed together.

A second situation arises when the container stops transmitting a packet in connection. To detect this, a timer periodically checks a frequency of sub-table (Conentry) hits. If the sub-table (Conentry) is not hit within a timer interval (e.g., 10 seconds), the table manager (SCON flusher) is activated to free the sub-table (Conentry). That is, table information (i.e., sub-table) not used for a preset interval (understandable as a meaning that is not checked or not hit) may be deleted.

The table manager (SCON flusher) may be designed to handle a situation in which an existing connection is newly updated, that is, refreshed. When TCP connection is closed and then refreshed, the sub-table (Conentry) needs to be flushed and updated accordingly. To detect this situation, a SYNC flag of the TCP packet is monitored. This monitoring is particularly important for IoT devices since TCP-based protocols, such as MQTT/HTTP, heavily use short-lived messages for energy efficiency.

The average expert in the technical field of the present invention may easily deduce that the aforementioned table generator or table manager may be functionally and logically separated, and that each component is not necessarily divided into a separate physical device or written in a separate code.

Also, “˜ unit” herein may represent functional/structural combination of hardware to perform the technical spirit of the invention and software to run the hardware. For example, “˜ unit” may represent a logical unit of a predetermined code and a hardware resource for executing the predetermined code and does not necessarily indicate a physically connected code or one type of hardware.

### Implementation and Evaluation

All components of the proposed method (SCON) are implemented on Debian GNU/Linux 11 (bullseye) using Linux kernel version 5.10. The implementation includes 2K lines of C code. Additionally, a configuration option that disables the proposed method (SCON) may be provided. Experimental settings are identical to those explained above.

Conducted are two sets of experiments, that is, 1) real-world applications and 2) micro-benchmarks. As the real-world applications, the effectiveness of the proposed method (SCON) is evaluated with 1) HTTP traffic scenario and 2) MQTT traffic scenario. This is because most IoT traffic is generated using HTTP or MQTT protocols. For both scenarios, an amount of CPU cycles and job completion time of transmitting the IoT traffic are measured.

As micro-benchmarks, CPU usage and network throughput are evaluated by gradually increasing a TCP packet size from 32 B to 1 KB. This packet size range includes both IoT packets and common datacenter packets. Also, a processing time per packet and a processing time per function symbol are analyzed using detailed profiling similar to FIG. 4. Also, a flow completion time (FCT) for IoT traffic is measured and 99% tail values are presented from the results. Lastly, the performance of the proposed method (SCON) using the UDP is described. Each experiment is conducted at least five times and the average values are recorded. The native Linux process, container, and SCON are compared.

### 1. Real-World Applications

1.1 HTTP. Initially, the HTTP performance of the proposed method (SCON) is tested. To this end, HTTP traffic is generated by running Nginx (version 1.23.2) on the Raspberry Pi. On the opposite side, there runs wrk2 on the Intel server and mpstat to measure network performance and CPU usage.

For each connection from an IoT device, wrk2 spawns a single thread and requests a 64 B HTML file. In settings, an input is set as 2K requests/s, which is close to the upper limit of the container's capability. Also, the CPU usage is measured through mpstat and HTTP latency is measured from wrk2. Here, the measured latency is an amount of time used to transmit a request and receive a corresponding reply. Each experiment proceeds for 10 seconds.

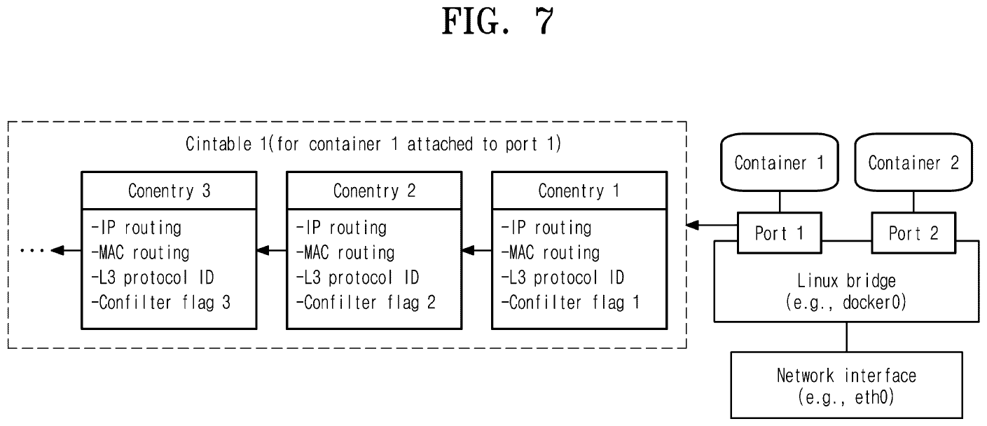

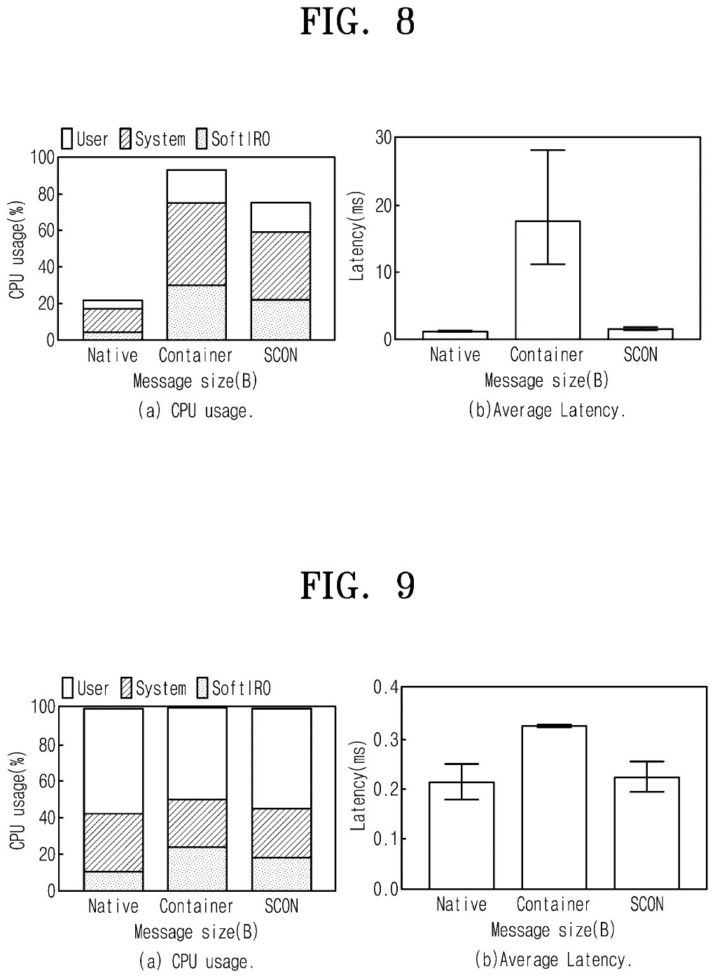

CPU usage. (a) of FIG. 8 shows the CPU usage in detail. Although the identical 64 B file is used for experiments, native, container, and the proposed method (SCON) show quite different CPU usage. In comparison to the container, the proposed method (SCON) reduces 19% of CPU usage. In particular, the proposed method (SCON) reduces 26% of CPU cycles used for SoftIRQ processing. As a result, the gap in total CPU usage between the native and the container to achieve the required throughput declines by 25% using the proposed method (SCON).

HTTP latency. (b) of FIG. 8 shows the average HTTP latency reported by wrk2. Here, bars represent average values and whiskers represent ranges. The container exhibits much more pronounced HTTP latency than the native, which is 14 times longer. On the other hand, the proposed method (SCON) reduces the latency by 10 times compared to the container. In particular, the latency difference between the native and the container is 1325% and the latency between the native and the proposed method (SCON) is 31%, which shows 42 times improvement.

1.2 MQTT. Next, MQTT, a widely used data streaming protocol in IoT devices, is evaluated. MQTT provides “MQTT broker” that intervenes between data publishers (e.g., IoT devices) and subscribers (e.g., edge cloud servers). The MQTT broker receives a variety of data from the publishers and delivers the same to proper subscribers. For experiments, the MQTT protocol of version 2.0.15 is used.

MQTTLoader and Mosquitto are used to execute MQTT components as follows. An MQTT publisher runs on Raspberry Pi and a broker and a subscriber run on the Intel server. Messages including 64 B data each is generated from the MQTT publisher (Raspberry Pi) using MQTTLoader. During each trial, one million messages are transmitted within 60 seconds. The broker receives the one million messages and then delivers the same to the subscriber (Intel server).

The experiments are repeated at least five times and the average values are presented. CPU usage and MQTT latency are measured. The MQTT latency includes a processing time from message generation by the publisher to message reception by the subscriber. The CPU usage is measured through mpstat and the latency is measured through MQTTLoader.

CPU usage. (a) of FIG. 9 shows the CPU usage of MQTT traffic. When comparing a native environment and a container environment, the container environment consumes much more CPU cycles for packet processing (SoftIRQ), which is 2.2 times higher. Due to this high processing SoftIRQ, a user time of the container environment experiences a decrease in CPU cycles (0.87 times), which results in poor performance. On the other hand, the proposed method (SCON) reduces the SoftIRQ consumption of the container by 24%, which leads to improving the MQTT performance.

MQTT latency. (b) of FIG. 9 shows the MQTT latency. Here, average values are represented by bars and ranges are expressed by whiskers. When comparing the native environment and the container environment, the latency of the container environment increases by 1.5 times. On the other hand, when comparing the container environment and the proposed method (SCON), the proposed method (SCON) reduces the latency by 31%. Furthermore, when comparing the native environment and the proposed method (SCON), the delay of the proposed method (SCON) is only 5% higher than the native environment (at least 2%). The results show that the proposed method (SCON) significantly enhances the MQTT latency and greatly helps the real-world application scenario of IoT devices.

### 2. Micro-Benchmarks

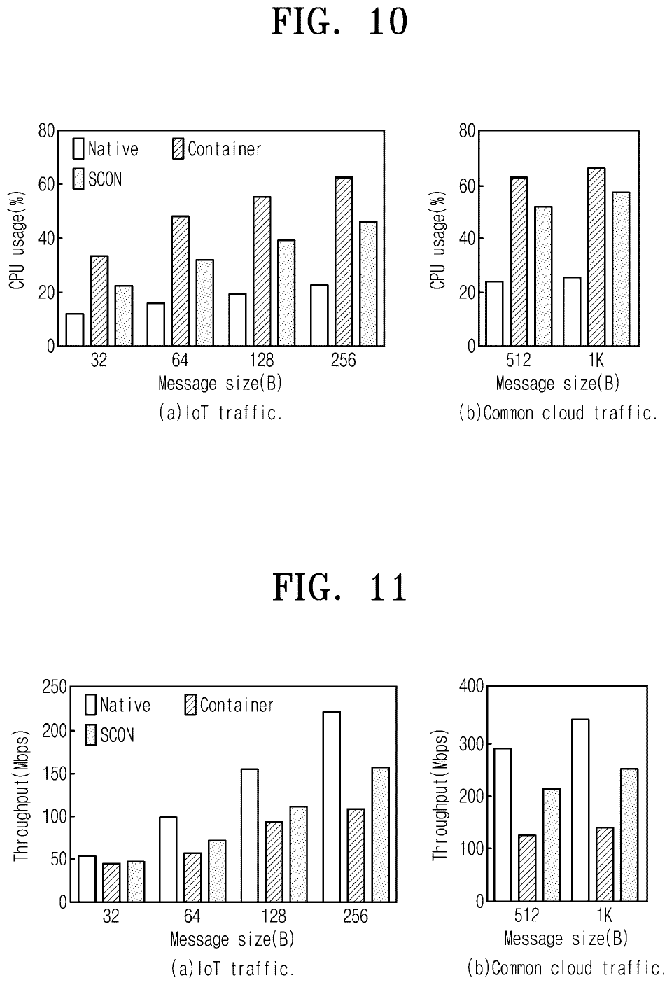

2.1 CPU usage. TCP packets are generated using iperf and CPU usage (%) is measured using mpstat. As described above, the packet size is classified into 1) IoT traffic (32 B to 256 B, (a) of FIG. 10) and 2) common cloud traffic (512 B and 1 KB, (b) of FIG. 10). Each bar of FIG. 10 shows the average CPU cycles for SoftIRQ processing (y-axis) per packet size (x-axis).

For the CPU usage, focus is made on the SoftIRQ part because it corresponds to packet processing overhead that the proposed method (SCON) aims to improve. As stated above, all experiments are conducted on a single CPU core and the CPU core is fully utilized in all cases (100%). By subtracting the SoftIRQ usage presented in FIG. 10 from the total CPU usage of 100% (one core), the CPU usage mainly utilized by a user may be acquired. Therefore, minimizing SoftIRQ usage helps in securing more CPU cycles for IoT applications.

FIG. 10 shows an increase in the CPU usage of SoftIRQ according to an increase in the packet size for all cases. This is because the number of packets generated at a user level and the number of system calls processed at a system level decrease according to an increase in the packet size. Also, (a) of FIG. 10 shows that the proposed method (SCON) reduces CPU cycles consumed in SoftIRQ by 20% on average compared to the container. In particular, the CPU usage reduction is 26% for 64 B packets. For common cloud traffic ((b) of FIG. 10), the proposed method (SCON) also shows a reduction by 15% to 17% in SoftIRQ processing compared to the container.

2.2 Network throughput. Measured network throughput (Mbps) is illustrated in FIG. 11. The proposed method (SCON) improves the network throughput of the container. For IoT traffic, the proposed method (SCON) demonstrates 12% higher network throughput on average compared to the container in (a) of FIG. 11. Also, the proposed method (SCON) reduces the throughput gap between the native and the container by 19% on average. When processing 64 B packets, the proposed method (SCON) improves the throughput in the container by up to 18% and reduces the gap between the container and the native by up to 23%. For common cloud traffic, the proposed method (SCON) improves the network throughput by 37% on average and by up to 45% with 512 B packets in (b) of FIG. 11. Also, gap reductions in network throughput between the native and the container are 40% on average and up to 47%. Such results show that the proposed method (SCON) effectively reduces the CPU usage and improves container networking throughput on both IoT traffic and cloud traffic.

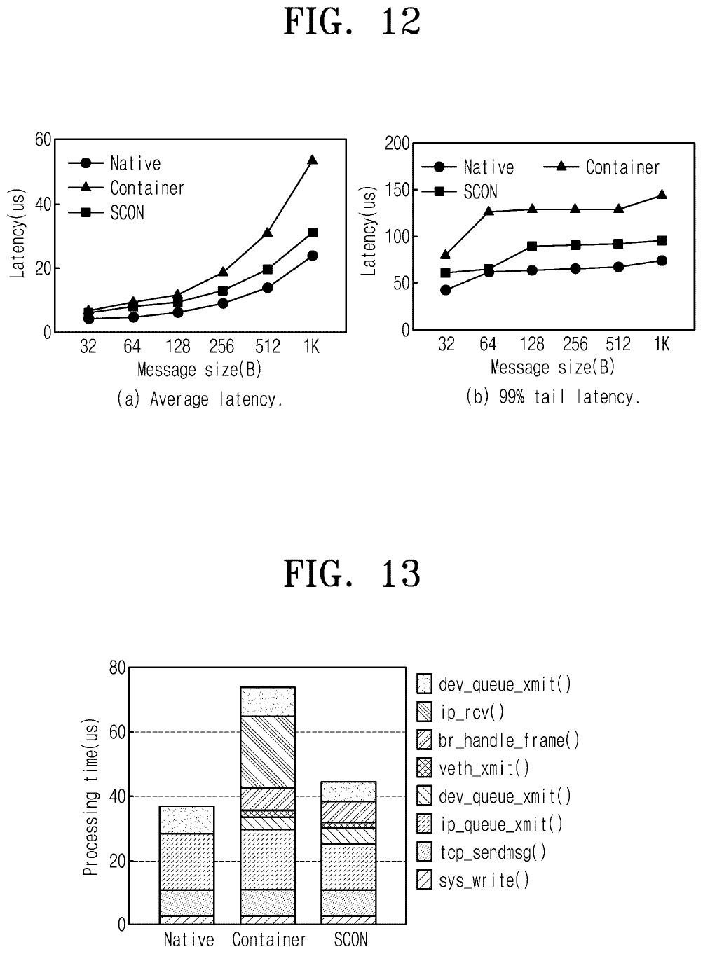

2.3 Per packet latency. The per packet latency is measured using Netperf by changing the packet size from 32 B to 1 KB. (a) of FIG. 12 and (b) of FIG. 12 show the average and 99% tail latency for transmitting TCP packets from an IoT client to a Linux edge server for 10 seconds, respectively. The proposed method (SCON) reduces the average latency by 25% on average compared to the container and reduces the gap between the native and the container by 49% on average. For 99% tail latency, the proposed method (SCON) reduces 32% of the container latency on average and minimizes the gap between the native process and the container by 66% on average.

2.4 Processing time per function symbol. Here, the impact of the proposed method (SCON) is investigated by conducting the same profiling as shown above. An amount of time used to process each function in the networking stack of the container in IoT when transmitting TCP packets of size 64 B is measured. FIG. 13 illustrates a per packet execution time on average in the native, the container, and the proposed method (SCON). Each bar includes profiled functions, such as ip_rcv, br_handle_frame, and veth_xmit.

The proposed method (SCON) reduces the total time used to process a single packet by 43% compared to the container. While the CPU usage of the container increases 99% than the native, a difference between SCON and the native is 20%, which is a five-fold improvement. More specifically, the proposed method (SCON) saves 22 μs in ip_rcv, maintaining an amount of time used in other symbols similar to the container. This indicates that the second packet processing path (SCON express forward) successfully reduces the overhead caused by additional and repetitious packet processing in the existing container networking stack.

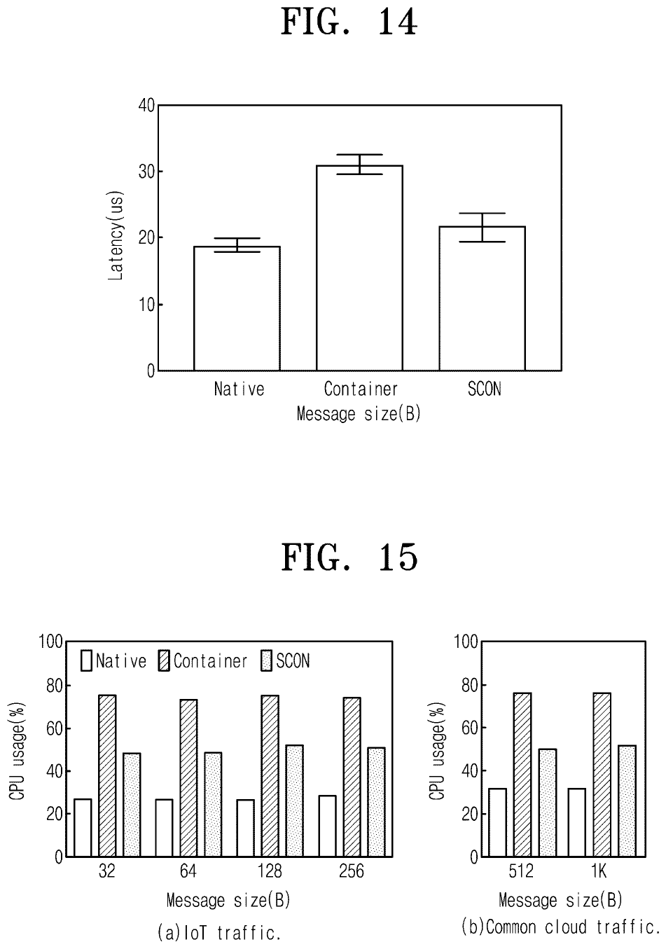

2.5 Flow completion time (FCT). The FCT that is a time for accomplishing a number of IoT packets is measured. IoT traffic is generated on Raspberry Pi using a traffic generator. The packets are generated according to size distribution of IoT flows of sensor data. In each trial, 100 IoT traffic flows are transmitted through TCP connection to an Intel server. Each IoT flow includes a plurality of packets according to the distribution. After transmitting a single flow, the time for completing the corresponding flow (FCT) is measured. From 100 FCTs, 99% tail values are computed. The measurement is conducted at least five time and the average is presented. The measurement results are shown in FIG. 14. When comparing the proposed method (SCON) and the container, the proposed method (SCON) reduces the 99% tail FCT by 20%. Furthermore, the proposed method (SCON) decreases the gap between the native and the container from 12 ms to 2.9 ms, which indicates 4.1 times small.

2.6 Proposed method (SCON) on UDP. In an IoT domain, the UDP is employed as a lightweight protocol to facilitate low-power communication (e.g., CoAP). Since the proposed method (SCON) is an optimized technique on an IP layer, the proposed method (SCON) is compatible with the UDP without any modifications. Here, the CPU usage and network throughput are measured with similar settings to those described in the TCP evaluation, but generating UDP traffic from iperf.

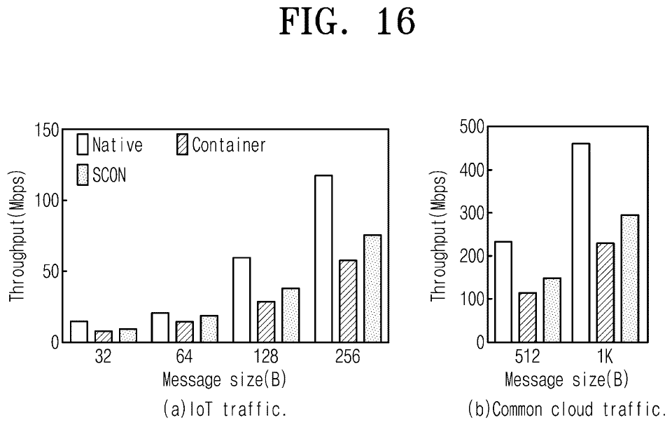

Initially, the CPU usage for SoftIRQ results in (a) and (b) of FIG. 15 for IoT traffic and cloud traffic, respectively, will be described. As the message size (x-axis) increases, both the IoT traffic and the cloud traffic show that the proposed method (SCON) reduces CPU cycles consumed in SoftIRQ by 33% on average. Also, when the packet size increases from 32 B to 256 B, the container experiences only 1.7% increase in CPU cycle consumption, which may be considered negligible.

Next, (a) and (b) of FIG. 16 show the network throughput of UDP for IoT traffic and common cloud traffic, respectively. For the IoT traffic ((a) of FIG. 16), the proposed method (SCON) demonstrates 32% higher throughput on average compared to the container. Also, the proposed method (SCON) reduces the throughput gap between the native process and the container by 39% on average. For the common cloud traffic ((b) of FIG. 16), the proposed method (SCON) improves throughput by 29% on average. Using the proposed method (SCON), the throughput gap between the native process and the container is reduced by 28% on average. The results show that the proposed method (SCON) effectively improves both the CPU usage and throughput for the UDP traffic as well as the TCP traffic.

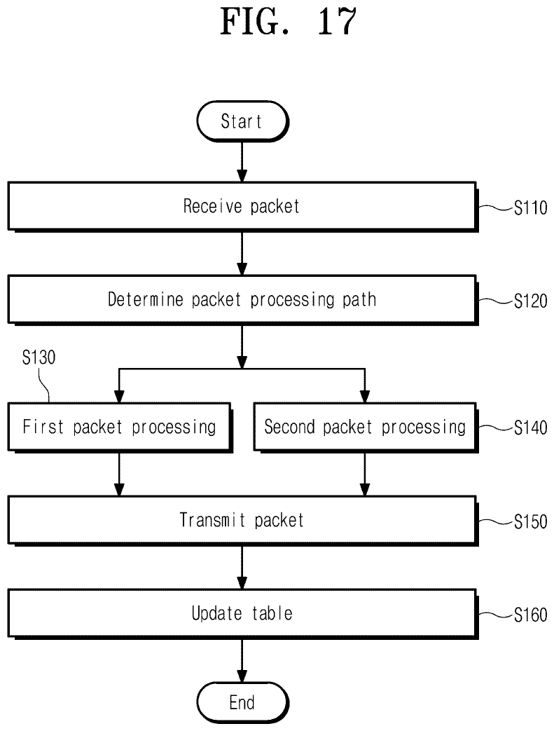

FIG. 17 is a flowchart illustrating a packet processing method according to an example embodiment.

Referring to FIG. 17, the packet processing method performed by a computing device including at least a processor and/or a memory (of container) may also be referred to as a packet lightweight method (of container). The computing device may include a PC, a server, a cloud server, and an edge cloud server. Depending on example embodiments, the computing device may also be referred to as a packet processing device or a packet lightweight device. Also, the computing device may also be implemented by two or more devices physically separated.

The packet processing device may serve to provide a container environment to an IoT device, such as Raspberry Pi, and to receive a predetermined packet from the IoT device and then perform packet processing and transmit the packet to an external network. The IoT device may also refer to the computing device that includes at least a processor and/or memory.

Also, the packet processing device and a plurality of IoT devices may construct a smart system, such as a smart factory system, a smart farm system, and a smart home system.

Hereinafter, when describing the packet processing method, further description related to repeated contents of the aforementioned description is omitted.

In operation S110, a packet is received from a container assigned to an IoT device. The packet may be a TCP packet and/or a UDP packet. Here, the packet may represent the result after the container performs packet processing for the packet received from the IoT device and packet processing in the container is described above and thus, further description related thereto is omitted. Also, the packet from the container may be received from a (Linux) bridge. Also, the IoT device may represent a predetermined computing device that transmits sensing results (sensing data) for, for example, temperature, humidity, wind speed, and illumination, to a packet processing device.

In operation S120, a packet processing path or a packet processing process is determined for the received packet. The packet processing path may be determined as one of a first packet processing path and a second packet processing path. The packet processing path may be determined based on a table prestored in the packet processing device (packet processing result storage table). That is, when information on a packet with the same connection information as connection of the received packet is prestored in the table, the received packet may be transferred to the second packet processing path. When information on the packet with the same connection information as the connection of the received packet is not stored in the table, the received packet may be transferred to the first packet processing path. Here, the same connection may represent that the packet has the same source IP address, destination IP address, source port address, destination port address, and L4 protocol ID as those of the received packet.

When the first packet processing path is determined as a packet to process the received packet in operation S120, the packet processing device processes the received packet by performing the first packet processing process in operation S130. When the second packet processing path is determined as the packet to process the received packet in operation S120, the packet processing device processes the received packet by performing the second packet processing process in operation S140.

In detail, the first packet processing process may follow, for example, call chain of the original Linux networking stack. In the first packet processing process, results of Netfilter, routing lookup, and header processing may be collected.

The second packet processing process omits an operation repeatedly performed, using the table. In detail, the second packet processing process records header information necessary for the packet (e.g., routing lookup results, TTL value, MTU size) in a packet header. Also, the second packet processing process may further include a checksum operation.

Also, the second packet processing process may include an operation of transmitting the packet to the network interface or dropping the packet according to Netfilter decision from (result of performing Netfilter) stored in the table. That is, if the Netfilter decision stored in the table is success, the corresponding packet may be transmitted to the network interface. If the Netfilter decision included in the table is discard, the corresponding packet may be dropped.

Depending on example embodiments, when the Netfilter result included in the table is “success” and the header processing result is “pass,” the corresponding packet may be transmitted to the network interface. When the Netfilter result included in the table is “discard,” the corresponding packet may be dropped regardless of the result of header processing. Also, when the result of header processing for the packet is considered “error,” the corresponding packet may be dropped and the table may be updated so that a next packet with the same connection information as the corresponding packet may be passed (e.g., delete information on the corresponding packet).

In operation S150, after performing the first packet processing process or the second packet processing process, the packet is transmitted to the external network. The packet transmitted to the network interface may be transmitted to the external network through a physical NIC.

In operation S160, the table is update. Although FIG. 17 illustrates that operation S160 is performed after operation S150, operation S160 may be performed after operation S130 depending on example embodiments. Update includes addition of information on a packet with new connection information, deletion of information when a predetermined period elapses after the container is discarded or information on a corresponding connection is hit, and deletion of information when header processing result is an error.

The aforementioned method according to example embodiments may be implemented in a form of a program executable by a computer apparatus. Here, the program may include, alone or in combination, a program instruction, a data file, and a data structure. The program may be specially designed to implement the aforementioned method or may be implemented using various types of functions or definitions known to those skilled in the computer software art and thereby available. Also, here, the computer apparatus may be implemented by including a processor or a memory that enables a function of the program and, if necessary, may further include a communication apparatus.

The program for implementing the aforementioned method may be recorded in computer-readable record media. The media may include, for example, a semiconductor storage device such as an SSD, ROM, RAM, and a flash memory, magnetic disk storage media such as a hard disk and a floppy disk, optical record media such as disc storage media, a CD, and a DVD, magneto optical record media such as a floptical disk, and at least one type of physical device capable of storing a specific program executed according to a call of a computer such as a magnetic tape.

Although some example embodiments of an apparatus and method are described, the apparatus and method are not limited to the aforementioned example embodiments. Various apparatuses or methods implementable in such a manner that one of ordinary skill in the art makes modifications and alterations based on the aforementioned example embodiments may be an example of the aforementioned apparatus and method. For example, although the aforementioned techniques are performed in order different from that of the described methods and/or components such as the described system, architecture, device, or circuit may be connected or combined to be different form the above-described methods, or may be replaced or supplemented by other components or their equivalents, it still may be an example embodiment of the apparatus and method.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

While the present invention is described above referencing a limited number of embodiments and drawings, those having ordinary skill in the relevant field of art would understand that various modifications and alterations can be derived from the descriptions set forth above. For example, similarly adequate results can be achieved even if the techniques described above are performed in an order different from that disclosed, and/or if the elements of the system, structure, device, circuit, etc., are coupled or combined in a form different from that disclosed or are replaced or substituted by other elements or equivalents. Therefore, various other implementations, various other embodiments, and equivalents of the invention disclosed in the claims are encompassed by the scope of claims set forth below.

What is claimed is:

1. A packet processing method performed by a server that provides a container environment to an Internet of things (IoT) device, the packet processing method comprising:
receiving a packet from a container assigned to the IoT device;
determining a packet processing path to process the packet;
processing the packet according to the determined packet processing path; and
transmitting the packet of which packet processing is completed to an external network.

2. The packet processing method of claim 1, wherein the determining of the packet processing path is performed using a table in which packet processing results are stored.

3. The packet processing method of claim 2, wherein the determining of the packet processing path comprises determining a first packet processing path as the packet processing path when connection information of the packet is not the same as connection information of a previously received packet, and determining a second packet processing path as the packet processing path when the connection information of the packet is the same as the connection information of the previously received packet.

4. The packet processing method of claim 3, wherein the connection information includes a source IP address, a destination IP address, a source port address, a destination address, and an L4 protocol ID.

5. The packet processing method of claim 3, wherein a packet processing process according to the first packet processing path includes Netfilter, routing lookup, and header processing.

6. The packet processing method of claim 3, wherein a packet processing process according to the second packet processing path records the routing lookup results stored in the table, TTL value, and MTU size in a packet header of the packet and performs header processing including a checksum operation.

7. The packet processing method of claim 6, wherein the packet processing process according to the second packet processing path drops the packet when a result of performing Netfilter stored in the table is discard.

8. The packet processing method of claim 6, wherein the packet processing process according to the second packet processing path transmits the packet to a network interface when a result of performing Netfilter stored in the table is discard and a result of the packet header processing for the packet is pass.

9. The packet processing method of claim 6, wherein the packet processing process according to the second packet processing path drops the packet when a result of the packet header processing for the packet is an error.

10. The packet processing method of claim 5, wherein a result of the packet processing process according to the first packet processing path is updated to the table.

11. The packet processing method of claim 10, further comprising:
deleting information corresponding to the container stored in the table when the container is discarded.

12. The packet processing method of claim 10, further comprising:
deleting information on a connection not hit within a preset time interval from information stored in the table.

13. The packet processing method of claim 9, further comprising:
deleting information on a connection of which the header processing result is an error from information stored in the table.
